(19) United States
(12) Patent Application Publication
(10) Pub. No.: US 2007/0150287 A1
(43) Pub. Date: Jun. 28, 2007

(54) Method for driving a dialog system

(76) Inventors: Thomas Portele, Bonn (DE); Frank Thiele, Aachen (DE)

Correspondence Address: Philips Electronics North America Corporation;Corporate Paten Counsel, PO Box 3001, Briarcliff Manor, NY, 10510, US

(21) Appl. No.: 10/566,512

(22) PCT Filed: Jul. 22, 2004
(86) PCT No.: PCT/IB04/51284

§ 371 Date: Jul. 11, 2006

(30) Foreign Application Priority Data
Aug. 1, 2003 (EP) 03102402.9

(51) Int. Cl. G10L 21/00

(52) U.S. Cl. 704/275

(57) ABSTRACT

The invention describes a method for driving a dialog system (1) comprising an audio interface (11) for processing audio signals (3,6). The method deduces characteristics (2) of an expected audio input signal (3) and generates audio interface control parameters (4) according to these characteristics (2). The behaviour of the audio interface (11) is optimised based on the audio interface control parameters (4). Moreover the invention describes a dialog system (1) comprising an audio interface (11), a dialog control unit (12), a predictor module (13) for deducing characteristics (2) of an expected audio input signal (3), and an audio optimiser (14) for optimising the behaviour of the audio interface (11) by generating audio input control parameters (4) based on the characteristics (2).

This invention relates in general to a method for driving a dialog system, in particular a speech-based dialog system, and a corresponding dialog system.

Recent developments in the area of man-machine interfaces have led to widespread use of technical devices which are operated through a dialog between the device and the user of the device. Some dialog systems are based on the display of visual information and manual interaction on the part of the user. For instance, almost every mobile telephone is operated by means of an operating dialog based on showing options on a display of the mobile telephone, and the user's pressing on the appropriate button to choose a particular option. Such a dialog system is only practicable in an environment where the user is free to observe the visual information on the display and to manually interact with the dialog system. However in an environment where the user must concentrate on another task, such as driving a vehicle, it is impracticable for the user to look at a screen to determine his options. Furthermore, it is often not possible for the user to manually enter his choice or it might be that in doing so, he places himself in a dangerous situation.

An at least partially speech-based dialog system however allows a user to enter into a spoken dialog with the dialog system. The user can issue spoken commands and receive visual and/or audible feedback from the dialog system. One such example might be a home electronics management system, where the user issues spoken commands to activate a device e.g. the video recorder. Another example might be the operation of a navigation device or another device in a vehicle in which the user asks questions of or directs commands at the device, which gives a response or asks a question in return, so that the user and the device enter into a dialog. Other dialog or conversational systems are in use, realised as telephone dialogs, for example a telephone dialog that provides information about local restaurants and how to locate them, or a telephone dialog providing information about flight status, and enabling the user to book flights via telephone. A common feature of these dialog systems is an audio interface for recording and processing sound input including speech, and which can be configured by means of various parameters, such as input sound threshold, final silence window etc.

One disadvantage of such dialog systems is that speech input provided by the user is almost always accompanied by some amount of background noise. Therefore, one control parameter of an audio interface for a speech-based dialog system might specify the level of noise below which any sound is to be regarded as silence. Only if a sound is louder than, i.e. contains more signal energy than the silence threshold, is it regarded as a sound. Unfortunately, the background noise might vary. The background noise level might, for example, increase as a result of a change in the environmental conditions e.g. the driver of a vehicle accelerates, with the result that the motor is louder, or the driver opens the windows, so that noise from outside the vehicle contributes to the background noise. Changes in the level of background noise might also arise owing to an action taken by the dialog system in response to a spoken user command, such as to activate the air conditioning. The subsequent increase in background noise has the effect of lowering the signal-to-noise ratio on the audio input signal. It might also lead to a situation in which the background noise exceeds the silence threshold and be incorrectly interpreted as a result. On the other hand, if the silence threshold is too high, the spoken user input might fail to exceed the silence threshold and be ignored as a result.

Another disadvantage of current dialog systems is that other threshold control parameters are also often configured to cover as many eventualities as possible, and are generally set to fixed values. For example, the final silence window (elapsed time between user's last vocal utterance and system's decision that user has concluded speaking) is of fixed length, but the length of time that elapses after the user has actually finished speaking depends to a large extent on the nature of what the user has said. For example a simple yes/no answer to a straightforward question posed by the dialog system does not require a long final silence window. On the other hand, the response to an open-ended question, such as which destinations to visit along a particular route, can be of any duration, depending on what the user says. Therefore the final silence window must be long enough to cover such responses, since a short value might result in the response of the user being cut off before completion. Spelled input also requires a relatively long final silence window, since there are usually longer pauses between spelled letters of a word than between words in a phrase or sentence. However, a long final silence window results in a longer response time for the dialog system, which might be particularly irritating in the case of a series of questions expecting short yes/no responses. Since the user must wait for at least as long as the duration of the final silence window each time, the dialog will quite possibly feel unnatural to the user.

Therefore, an object of the present invention is to provide an easy and inexpensive method for optimising the performance of the dialog system, ensuring good speech recognition under difficult conditions while offering ease of use.

To this end, the present invention provides a method for driving a dialog system comprising an audio interface for processing audio signals, by deducing characteristics of an expected audio input signal, generating audio interface control parameters according to these characteristics, and applying the parameters to automatically optimise the behaviour of the audio interface. Here, the expected audio input signal might be an expected spoken input e.g. the spoken response of a user to an output (prompt) of the dialog system along with any accompanying background noise.

A dialog system according to the invention comprises an audio interface, a dialog control unit, a predictor module and an optimiser unit. The characteristics of the expected audio input signal are deduced by the predictor module, which uses information supplied by the dialog control unit. The dialog control unit resolves ambiguities in the interpretation of the speech content, controls the dialog according to a given dialog description, sends speech data to a speech generator for presentation to the user, and prompts for spoken user input. The optimiser module then generates the audio interface control parameters based on the characteristics supplied by the predictor module.

Thus, the audio interface adapts optimally to compensate for changes on the audio input signal, resulting in improved speech recognition and short system response times, while ensuring comfort of use. In this way the performance of the dialog system is optimised without the user of the system having to issue specific requests.

The audio interface may consist of audio hardware, an audio driver and an audio module. The audio hardware is the “front-end” of the interface connected to a means for recording audio input signals which might be stand-alone or might equally be incorporated in a device such as a telephone handset. The audio hardware might be for example a sound-card, a modem etc.

The audio driver converts the audio input signal into a digital signal form and arranges the digital input signal into audio input data blocks. The audio driver then passes the audio input data blocks to the audio module, which analyses the signal energy of the audio data to determine and extract the speech content.

In a system where the audio interface is an input/output interface, the audio module, audio driver and audio hardware could also process audio output. Here, the audio module receives digital audio information from, for example, a speech generator, and passes the digital information in the appropriate form to the audio driver, which converts the digital output signal into an audio output signal. The audio hardware can then emit the audio output signal through a loudspeaker. In this case the audio interface allows a user to engage in a spoken dialog with a system by speaking into the microphone and hearing the system output prompt over the loudspeaker. The invention is not limited to a two-way spoken dialog, however. It might suffice that the audio interface process input audio including spoken commands, while a separate output interface presents the output prompt to the user, for example visually on a graphical display.

The dependent claims disclose particularly advantageous embodiments and features of the invention whereby the system could be further developed according to the features of the method claims.

Preferably, the control parameters comprise recording and/or processing parameters for the audio driver of the audio interface. The audio driver supplies the audio module with blocks of audio data. Typically such a block of audio data consists of a block header and block data, where the header has a fixed size and format, whereas the size of the data block is variable. Blocks can be small in size, resulting in rapid system response time but an increase in overhead. Larger blocks result in a slower system response time and result in a lower overhead. It might often be desirable to adjust the audio block size according to the momentary capabilities of the system. To this end, the audio driver informs the optimiser of the current size of the audio blocks. Depending on information supplied by the dialog control module, the optimiser might change the parameters of the audio driver so that the size of the audio blocks is increased or decreased as desired. Other parameters of the audio driver might be the recording level, i.e. the sensitivity of the microphone. Depending on information about the quality of the input speech and the level of background noise obtained by processing the input signal or supplied over an interface to an external application, the optimiser may adjust the sensitivity of the microphone to best suit the current situation.

The control parameters may also comprise threshold parameters for the audio module of the audio interface. Such threshold parameters might be the energy level for speech or silence, i.e. the silence threshold applied by the audio module in detecting speech on the audio input signal. Any signal with higher energy levels than the silence threshold is considered by the speech detection algorithms. Another threshold parameter might be the timeout value which determines how long the dialog system will wait for the user to reply to an output prompt, for example the length of time available to the user to select one of a number of options put to him by the dialog system. The predictor unit determines the characteristics of the user's response according to the type of dialog being engaged in, and the optimiser adjusts the timeout value of the audio module accordingly. A further threshold parameter concerns the final silence window, i.e. the length of elapsed time following an utterance after which the dialog control unit concludes that the user has finished speaking. Depending on the type of dialog being engaged in, the optimiser might increase or decrease the length of the final silence window. In the case of expected spelled input for example, it is advantageous to increase the length of the final silence window so that none of the letters of the spelled word are overlooked.

The control parameters may be applied directly to the appropriate modules of the audio interface, or they may be taken into consideration along with other pertinent parameters in a decision making process of the modules of the audio interface. These other parameters might have been supplied by the optimiser prior to the current parameters, or might have been obtained from an external source.

In a preferred embodiment of the invention, the characteristics of the expected audio input signal are deduced from data currently available and/or from earlier input data.

In particular, characteristics of the expected audio input signal may be deduced from a semantic analysis of the speech content of the input audio signal. For example, the driver of a vehicle with an on-board dialog system issues a spoken command to turn on the air-conditioning and adjust to a particular temperature, for example, “Turn on the air conditioning to about, um, twenty-two degrees.” Once the audio input signal is processed and speech recognition is performed, a semantic analysis of the spoken words is carried out in a speech understanding module, which identifies the pertinent words and phrases, for example “turn on”, “air conditioning” and “twenty-two degrees”, and disregards the irrelevant words. The pertinent words and phrases are then forwarded to the dialog control unit so that the appropriate command can be activated. According to the invention, the predictor module is also informed of the action so that the characteristics of the expected audio input can be deduced. In this case the predictor module deduces from the data that one characteristic of a future input signal is a relatively high noise level caused by the air conditioning. The optimiser generates input audio control parameters accordingly, e.g. by raising the silence threshold, so that, in this example, the hum of the air-conditioner is treated as silence by the dialog system.

Preferably, the characteristics of the expected input signal may also be deduced from determined environmental conditions input data. In this arrangement of the invention, the dialog system is supplied with relevant data concerning the external environment. For example, in a vehicle featuring such a dialog system, information such as the rpm value might be passed on to the dialog system via an appropriate interface. The predictor module can then deduce from an increase in rpm value that a future audio input signal will be characterised by an increase in loudness. This characteristic is subsequently passed to the optimiser which in turn generates the appropriate audio input control parameters. The driver now opens one or more windows of the car by manually activating the appropriate buttons. An on-board application informs the dialog control unit of this action, which supplies the predictor module with the necessary information so that the optimiser can generate appropriate control parameters for the audio module to compensate for the resulting increase in background noise.

Advantageously, characteristics of the expected audio input signal may also be deduced from an expected response to a current prompt of the dialog system. For example, in the case of a navigation system incorporating a dialog system, the driver of the vehicle might ask the navigation system “Find me the shortest route to Llanelwedd.” The dialog control module processes the command but does not recognise the name of the destination, and issues an output prompt accordingly, requesting the driver to spell the name of the destination. The predictor module deduces that the expected spelled audio input will consist of short utterances separated by relatively long silences, and informs the optimiser of these characteristics. The optimiser in turn generates the appropriate input control parameters, such as an increased final silence window parameter, so that all spoken letters of the destination can successfully be recorded and processed.

Other objects and features of the present invention will become apparent from the following detailed descriptions considered in conjunction with the accompanying drawing. It is to be understood, however, that the drawing is designed solely for the purposes of illustration and not as a definition of the limits of the invention, for which reference should be made to the appended claims.

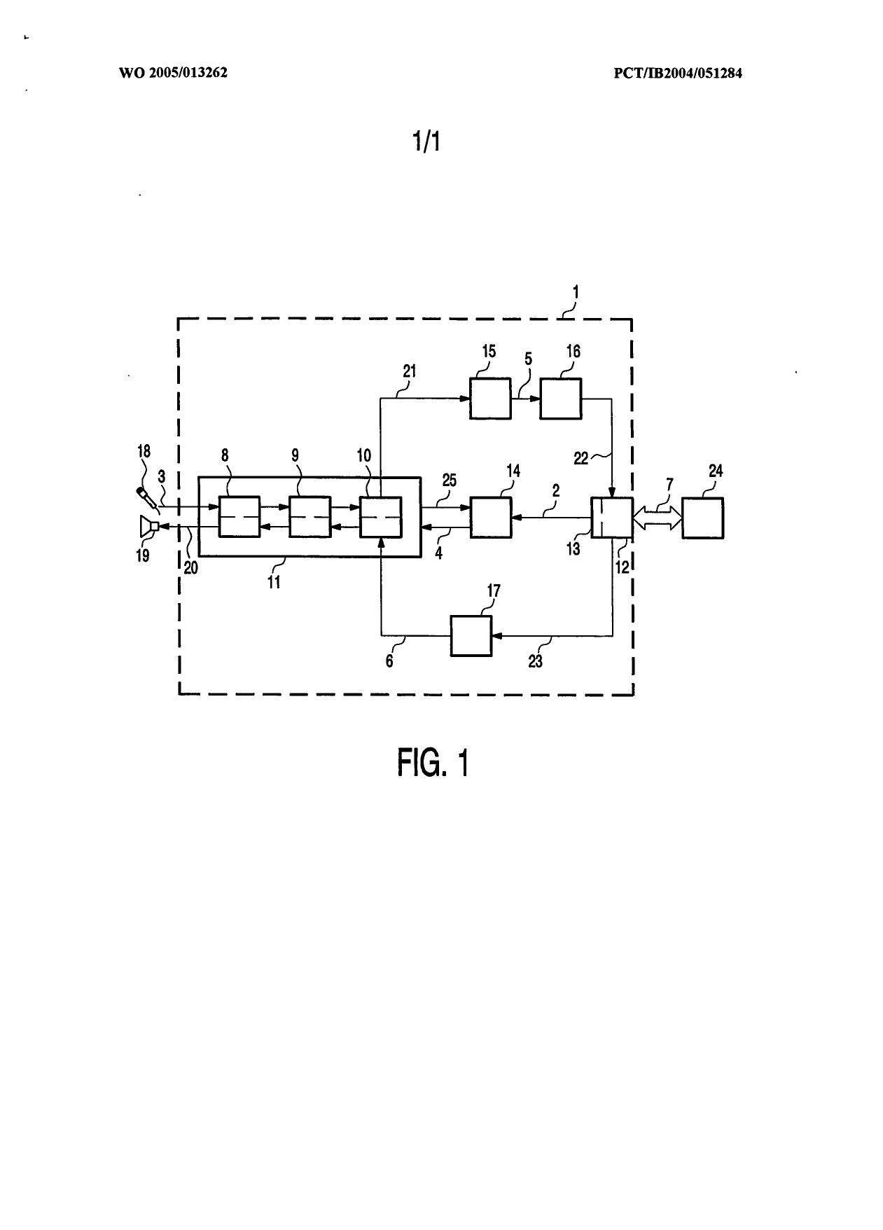

The sole figure, FIG. 1, is a schematic block diagram of a dialog system in accordance with an embodiment of the present invention.

In the description of the figure, which does not exclude other possible realisations of the invention, the system is shown as part of a user device, for example an automotive dialog system.

FIG. 1 shows a dialog system 1 comprising an audio interface 11 and various modules 12, 14, 15, 16, 17 for processing audio information.

The audio interface 11 can process both input and output audio signals, and consists of audio hardware 8, an audio driver 9, and an audio module 10. An audio input signal 3 detected by a microphone 18 is recorded by the audio hardware 8, for example a type of soundcard. The recorded audio input signal is passed to the audio driver 9 where it is digitised before being further processed by the audio module 10. The audio module 10 can determine speech content 21 and/or background noise. In the other direction, an output prompt 6 of the system 1 in the form of a digitised audio signal can be processed by the audio module 10 and the audio driver 9 before being subsequently output as an audio signal 20 by the audio hardware 8 connected to a loudspeaker 19.

The speech content 21 of the audio input 3 is passed to an automatic speech recognition module 15, which generates digital text 5 from the speech content 21. The digital text 5 is then further processed by a semantic analyser or “speech understanding” module 16, which examines the digital text 5 and extracts the associated semantic information 22. The relevant words 22 are forwarded to a dialog control module 12.

The dialog control module 12 determines the nature of the dialog by examining the semantic information 22 supplied by the semantic analyser 16, forwards commands to an external application 24 as appropriate, and generates digital prompt text 23 as required following a given dialog description.

In the event that spoken input 3 is required from the user, the dialog control module 12 generates digital input prompt text 23 which is furthered to a speech generator 17. This in turn generates an audio output signal 6 which is passed to the audio interface 11 and subsequently issued as a speech output prompt 20 on the loudspeaker 19.

The dialog control module 12 is connected in this example to an external application 24, here an on-board device of a vehicle, by means of an appropriate interface 7. In this way, a command spoken by the user to, for example, open the windows of the vehicle is appropriately encoded by the dialog control module 12 and passed via the interface 7 to the application 24 which then executes the command.

A predictor module 13 connected to, or in this case integrated in, the dialog control unit 12 determines the effects of the actions carried out as a result of the dialog on the characteristics of an expected audio input signal 3. For example, the user might have issued a command to open the windows of the car. The predictor module 13 deduces that the background noise of a future input audio signal will become more pronounced as a result. The predictor module 13 then supplies an optimiser 14 with the predicted characteristics 2 of the expected input audio signal, in this case, an increase in background noise with a lower signal-to-noise ratio as a result.

Using the characteristics 2 supplied by the predictor 13, the optimiser 14 can generate appropriate control parameters 4 for the audio interface 11. In this example, the optimiser 14 works to counteract the increase in noise by raising the silence threshold of the audio module 10. Once the car windows have been opened, the audio module 9 processes the digitised audio input signal with the optimised parameters 4 so that the raised silence threshold compensates for the increased background noise.

The audio interface 11 also supplies the optimiser 14 with information 25, such as the current level of background noise or the current size of the audio blocks. The optimiser 14 can apply this information 25 in generating optimised control parameters 4.

Depending on the type of output prompt 20, the user response might be in the form of a phrase, a sentence, or spelled words etc. For example, the output prompt 20 might be in the form of a straightforward question to which the user need only reply “yes” or “no”. In this case the predictor module 13 deduces that the expected input signal 3 will be characterised by a single utterance and of short duration, and informs the optimiser 14 module of these characteristics 2. The optimiser 14 generates control parameters 4 accordingly, for example by specifying a short timeout value for the audio input signal 3.

The external application can also supply the dialog system 1 with pertinent information. For example, the application 24 can continually supply the dialog system 1 with the rpm value of the vehicle. The predictor module 13 predicts an increase in motor noise for an increase in the rpm value, and deduces the characteristics 2 of the future input audio signal 3 accordingly. The optimiser 14 generates control parameters 4 to increase the silence threshold, thus compensating for the increase in noise. A decrease in the rpm value of the motor results in a lower level of motor noise, so that the predictor module 13 deduces a lower level of background noise on the input audio signal 3. The optimiser 14 then adjusts the audio input control parameters 4 accordingly.

All modules and units of the invention, with perhaps the exception of the audio hardware, could be realised in software using an appropriate processor.

Although the present invention has been disclosed in the form of preferred embodiments and variations thereon, it will be understood that numerous additional modifications and variations could be made thereto without departing from the scope of the invention. In one embodiment of the invention, the dialog system might be able to determine the quality of the current user's voice after processing a few utterances, or the user might make himself known to the system by entering an identification code which might then be used to access stored user profile information which in turn would be used to generate appropriate control parameters for the audio interface.

For the sake of clarity, throughout this application, it is to be understood that the use of “a” or “an” does not exclude a plurality, and “comprising” does not exclude other steps or elements. The use of “unit” or “module” does not limit realisation to a single unit or module.

1. A method for driving a dialog system (1) comprising an audio interface (11) for processing audio signals (3,6) wherein characteristics (2) of an expected audio input signal (3) are deduced, audio interface control parameters (4) are generated according to these characteristics (2), behaviour of the audio interface (11) is optimised based on the audio interface control parameters (4).

2. The method according to claim 1, wherein characteristics (2) are deduced from current and/or prior input data.

3. The method according to claim 2, wherein characteristics (2) are deduced from a semantic analysis of the speech content (5) of the input audio signal (3);

4. The method according to claim 2, wherein characteristics (2) are deduced from determined environmental conditions data.

5. The method according to claim 1, wherein characteristics (2) are deduced from an expected response to a current prompt (6) of the dialog system (1).

6. The method according to claim 1, wherein the control parameters (4) comprise recording and/or processing parameters for an audio driver (9) of the audio interface (11).

7. The method according to claim 1, wherein the control parameters (4) comprise threshold parameters for an audio module (10) of the audio interface (11).

8. A dialog system (1) comprising an audio interface (11), a dialog control unit (12), a predictor module (13) for deducing characteristics (2) of an expected audio input signal (3), an audio optimiser (14) for optimising the behaviour of the audio interface (11) by generating audio input control parameters (4) based on the characteristics (2).

9. The dialog system (1) according to claim 8, wherein the audio interface (11) consists of audio hardware (8) and/or an audio driver (9) and/or an audio module (10).
